(19) United States
(12) Patent Application Publication
(10) Pub. No.: US 2007/0097710 A1
(43) Pub. Date: May 3, 2007

(54) Light guide plate having micro-reflectors

(76) Inventors: Jee-Gong Chang, Tainan Hsien (TW); Yu-Bin Fang, Tainan Hsien (TW); Chi-Feng Lin, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/261,478

(22) Filed: Oct. 31, 2005

(51) Int. Cl. F21V 7/04

(52) U.S. Cl. 362/623; 362/626

(57) ABSTRACT

A light guide plate having micro-reflectors is applied to a back light module of a liquid crystal display. A light source is disposed on one side of the light guide plate. Each of the micro-reflectors is shaped like a pyramid protruding from the bottom of the light guide plate and comprises a transparent plane and two reflection planes. The transparent plane is disposed at right angle to the bottom of the light guide plate, facing and comparatively nearer to the light source. Both the reflection planes are inclined to the bottom of the light guide plate, facing the illuminating surface of the light guide plate and comparatively farther from the light source to reflect rays of light upward to increase luminance of the light guide plate, and thereby changing arrangement of the micro-reflectors to improve consistent luminance of the light guide plate.

### BACKGROUND OF THE INVENTION

(a) Field of the Invention

The present invention relates to a light guide plate having micro-reflectors, and more particularly, to a micro-reflector shaped like a pyramid to increase luminance of the light guide plate.

(b) Description of the Prior Art

Referring to FIG. 1 of the accompanying drawings for a schematic view of a micro-reflector 2 of a conventional light guide plate 1, the micro-reflector 2 with rough surface is created by using an etching method on a bottom 12 of the smooth light guide plate 1. The rays of light 50 continuing to convey through the surface of the micro-reflector 2 create reflected rays 51 or refracted rays 52 of light in scattering fashion. The reflected rays 51 of light pass through an illuminating surface 11 of the light guide plate 1 when the angle of incidence of the reflected rays 51 is smaller than the critical angle; or the reflected rays 51 are fully reflected back into the light guide plate 1 to continue passing on if the angle of incidence is greater than the critical angle.

FIG. 3(a) is a radar view of illuminating intensity of the rays of light leaving the illuminating surface 11 of the light guide plate 1, and FIG. 2 interprets those coordinates appearing in FIG. 3(a). Wherein, the abscissa indicates a horizontal angle (HA) with the movement of angle turns from a normal direction 13 of the illuminating surface 11 into a direction 14 vertical to a light source 4; meanwhile, the ordinate indicates a vertical angle (VA) with the movement of angle turns from the normal direction 13 of the illuminating surface 11 into a direction 15 in parallel with the light source 4.

As illustrated in FIG. 3(a), each closed curve represents the illuminating intensity defined as the luminous flux of unit solid angle. There are ten closed curves illustrated in FIG. 3(a) representing ten grades of illuminating intensity. The distribution of the illuminating intensity from the light guide plate 1, as shown in FIG. 3(a), approximates a Lambertian distribution; that is, closed curves in circles are produced with the illuminating intensity showing cosine distribution. When the illuminating intensity is converted into luminance value, the luminance value is equal in each direction.

Now referring to FIG. 3(b) for a perspective view of the illuminating intensity from the illuminating surface 11 of the light guide plate 1, the distribution of the illuminating intensity approximates spherical one, i.e., it resembles the Lambertian distribution to permit the observation changes of the illuminating intensity in angle or direction.

Furthermore, each of both micro-reflectors disclosed in U.S. Pat. Nos. 6,746,129 and 6,894,740 is shaped like a quadrangle-pyramid with the front two inclined planes abutted to each other of the quadrangle-pyramid facing the light source and the incident light continues to reflect on both abutted inclined planes to illuminate. Wherein, as taught in U.S. Pat. No. 6,746,129 a point-like light source is adapted and the micro-reflector is distributed at the light guide plate; and in U.S. Pat. No. 6,894,740, a linear light source is adapted with its both ends respectively provided with a point-like light source.

In general, the quadrangle-pyramid structure is comparatively more complicated; and in practice, those two abutted inclined planes among four abutted four inclined planes give insignificant illuminating results.

### SUMMARY OF THE INVENTION

The primary purpose of the present invention is to provide a light guide plate having micro-reflectors. Each of the micro-reflectors is shaped like a pyramid externally protruding from the bottom of the light guide plate to effectively increase the rays of light emitting toward an illuminating surface of the light guide plate and the luminance of the light guide plate.

To achieve the purpose, each of the micro-reflectors of the light guide plate of a preferred embodiment of the present invention is shaped like a pyramid disposed on and externally protruding from the bottom of the light guide plate. The pyramid includes a transparent plane and two reflection plans. The transparent plane is disposed at right angle to the bottom of the light guide plate, facing and comparatively nearer to the light source. The reflection planes are disposed at a certain inclination to the bottom of the light guide plate, facing the illuminating surface of the light guide plate and comparatively farther from the light source.

Both reflection planes cut each other with the cutting line referred to their direction on the light guide plate that is in parallel with the direction of the rays of light emitting from the light source. Alternatively, the cutting line of both reflection planes cutting each other tends to but not exactly in parallel with that of the rays of light emitting from the light source.

The micro-reflectors are regularly arranged on the light guide plate or at random.

The micro-reflectors are arranged on the light guide plate at random.

The structure of the micro-reflectors of the present invention is simple and the light guide direction is exact, allowing simulation and design roadmap in advance, and easier cost and quality control.

### BRIEF DESCRIPTION OF THE DRAWINGS

FIG. 1 is a schematic view showing a micro-reflector of a conventional light guide plate.

FIG. 2 is a schematic view showing the illuminating light from an illuminating surface of the conventional light guide plate (that also explains the coordinates given in FIGS. 3).

FIG. 3(a) is a radar view of the illumination intensity from the illuminating surface of the conventional light guide plate.

FIG. 3(b) is a perspective view of the illumination intensity from the illuminating surface of the conventional light guide plate.

FIG. 4(a) is a side view of micro-reflectors of a preferred embodiment of the present invention applied in a light guide plate.

FIG. 4(b) is an upward view of the micro-reflectors of the preferred embodiment of the present invention applied in the light guide plate (also as a first preferred embodiment of the present invention showing the distribution of the micro-reflectors of the present invention applied in the light guide plate).

FIG. 5(a) is a perspective view of the micro-reflector of the preferred embodiment of the present invention.

FIG. 5(b) is an upward view of the micro-reflector of the preferred embodiment of the present invention.

FIG. 5(c) is a top view of the micro-reflector of the preferred embodiment of the present invention.

FIG. 5(d) is a side view of the micro-reflector of the preferred embodiment of the present invention.

FIG. 6(a) is a perspective view of the conveyance behavior of the light through the micro-reflector of the preferred embodiment of the present invention

FIG. 6(b) is a top view of the conveyance behavior of the light through the micro-reflector of the preferred embodiment of the present invention

FIG. 6(c) is a side view of the conveyance behavior of the light through the micro-reflector of the preferred embodiment of the present invention.

FIG. 7 is a radar view of the distribution of the illuminating intensity of those rays of light emitting through the micro-reflectors of the preferred embodiment of the present invention with angles β and θ as the parameters.

FIG. 8 is a perspective view of the illuminating intensity of those rays of light emitting through the micro-reflectors of the preferred embodiment of the present invention with angles β=50° and θ=30° as the parameters.

FIG. 9 is a perspective view of the illuminating intensity of those rays of light emitting through the micro-reflectors of the preferred embodiment of the present invention with angles β=40° and θ=10° as the parameters.

FIG. 10 is a perspective view of the illuminating intensity of those rays of light emitting through the micro-reflectors of the preferred embodiment of the present invention with angles β=60° and θ=20° as the parameters.

FIG. 11 is a view of a second preferred embodiment of the present invention showing the distribution of the micro-reflectors on the light guide plate.

FIG. 12 is a view of a third preferred embodiment of the present invention showing the distribution of the micro-reflectors on the light guide plate.

FIG. 13 is a view of a fourth preferred embodiment of the present invention showing the distribution of the micro-reflectors on the light guide plate.

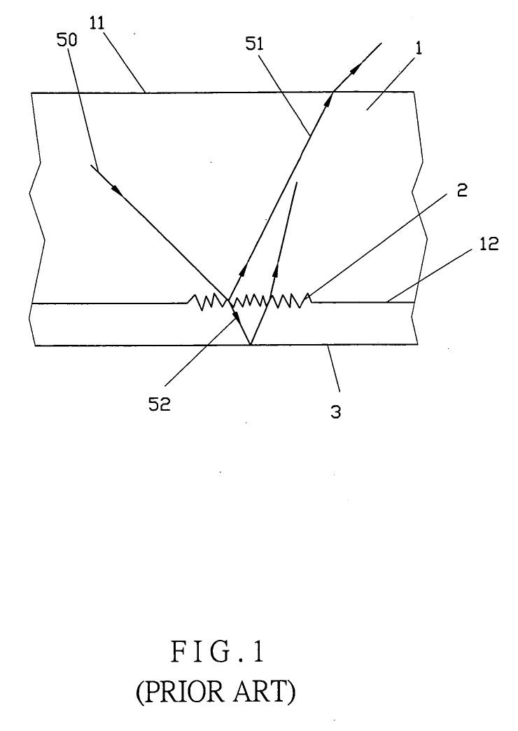

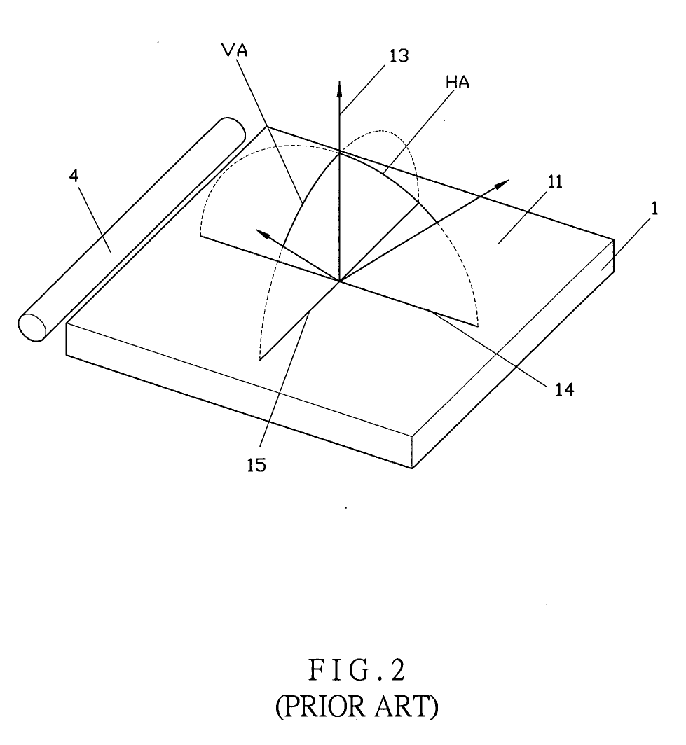

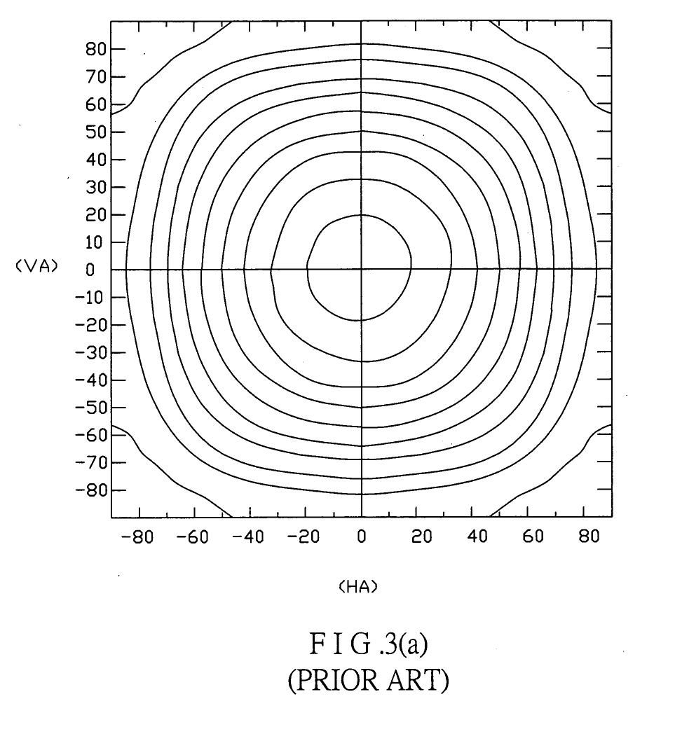

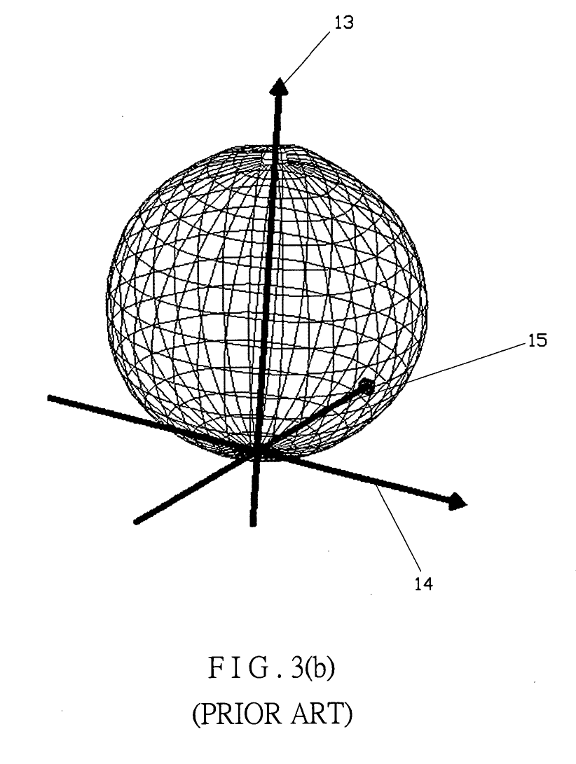

### DETAILED DESCRIPTION OF THE PREFERRED EMBODIMENTS

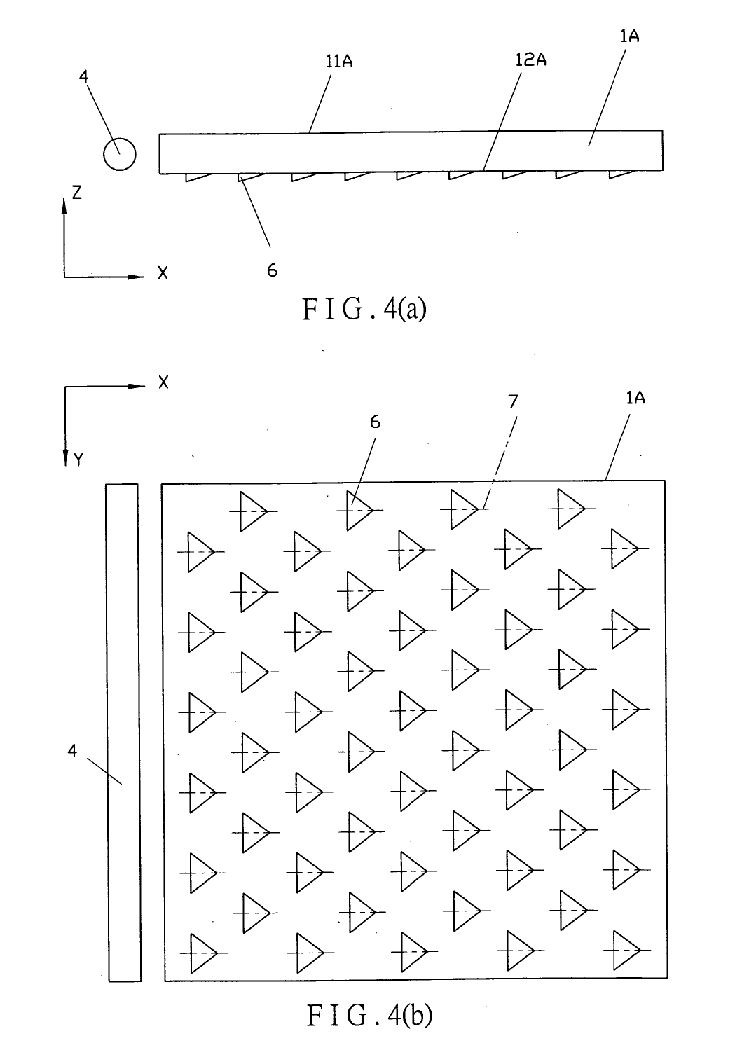

FIG. 4(a) is a schematic view of micro-reflectors 6 of a first preferred embodiment of the present invention applied in a light guide plate 1A. The light guide plate 1A comprises a plurality of micro-reflectors 6 disposed on a bottom 12A of the light guide plate 1A. Each micro-reflector 6 is shaped like a pyramid externally protruding from the bottom 12A of the light guide plate 1A to effective upgrade rays of light emitting from an illuminating surface 11A of the light guide plate 1A to increase its luminance.

FIG. 4(b) is a view of the first preferred embodiment showing the distribution of the micro-reflectors 6 on the light guide plate 1A. The micro-reflectors 6 are arranged in regular while all the micro-reflectors 6 indicate a direction 7 completely in parallel with the rays of light emitted from a linear light source 4. Rays of light emitted from the linear light source 4 enter into the light guide plate 1A to generate highly consistent of luminance in plane fashion.

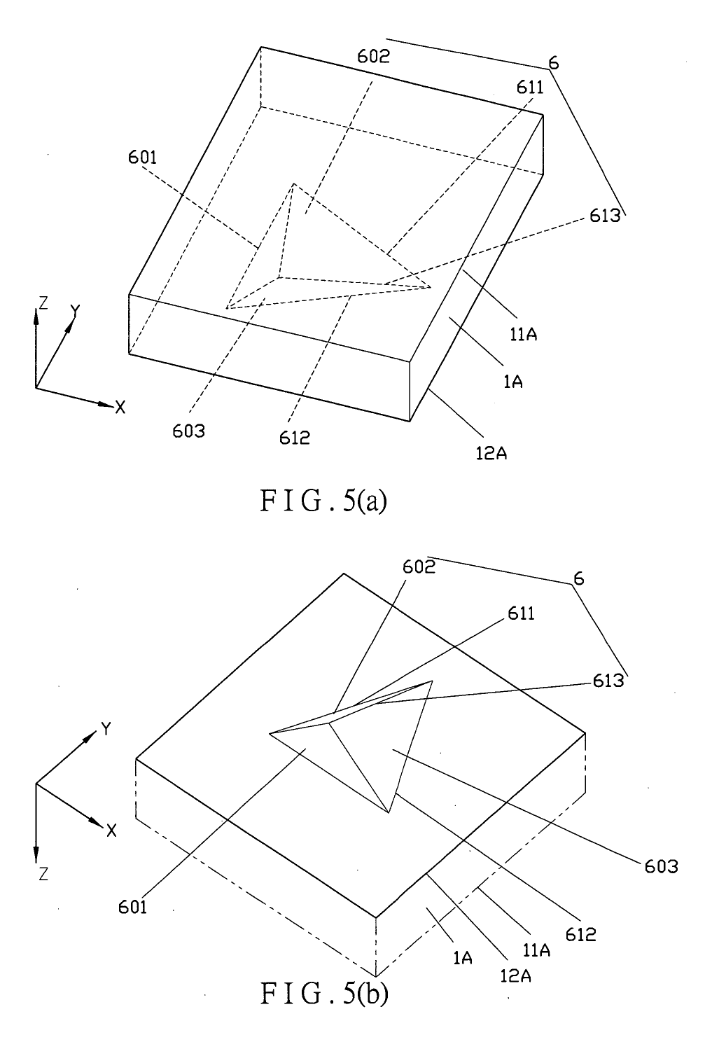

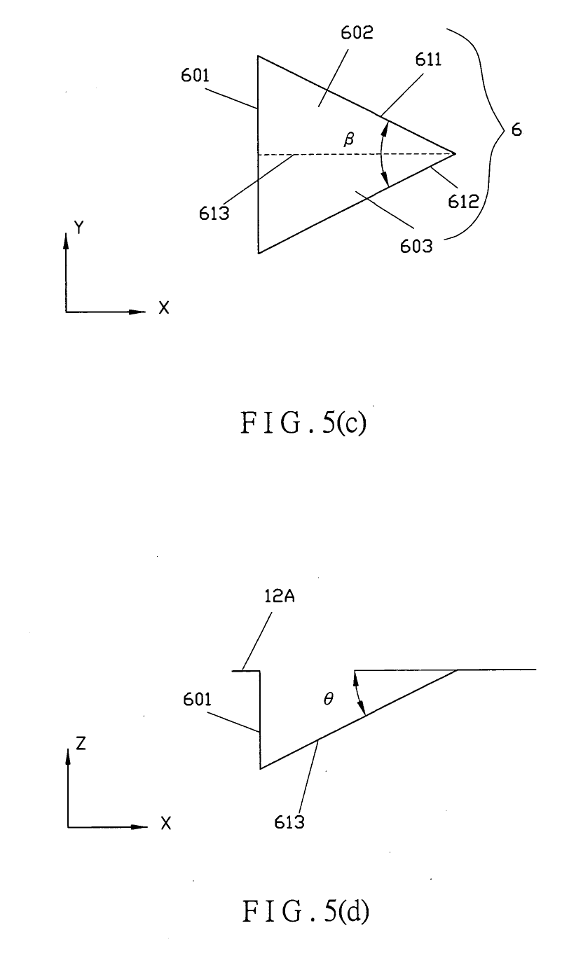

Referring to FIGS. 5(a) through 5(d) respectively for a perspective view, an upward view, a top view and a side view of the micro-reflector 6 of the preferred embodiment of the present invention, the micro-reflector 6 is shaped like a pyramid and comprises a transparent plane 601, and two reflection planes 602, 603. The transparent plane 601 is disposed at right angle to the bottom 12A of the light guide plate 1A, facing and comparatively nearer to the light source 4. Both the reflection planes 602, 603 are inclined to the bottom 12A of the light guide plate 1A, facing the illuminating surface 11A of the light guide plate 1A and comparatively farther from the light source 4. Both the reflection planes 602, 603 are capable of changing the forward direction of the rays of light on the light guide plate 1A. Once rays of light enter into the micro-reflectors 6, both the reflection planes 602, 603 reflect them upward to increase the luminance of the light guide plate 1A.

As illustrated in FIGS. 5(c) and 5(d), an angle β defined by two bases 611, 612 where both the reflection planes 602, 603 connect to the bottom 12A of the light guide plate 1A, and an angle θ defined by a sharp edge 613 where both the reflection planes 602, 603 meet are capable of changing the inclination of both the reflection planes 602, 603 that affects most the distribution of intensity of rays of light emitting upward. The sharp edge 613 where both the reflection planes 602, 603 meet points out the direction 7 of the micro-reflectors 6 as illustrated in FIG. 4(b).

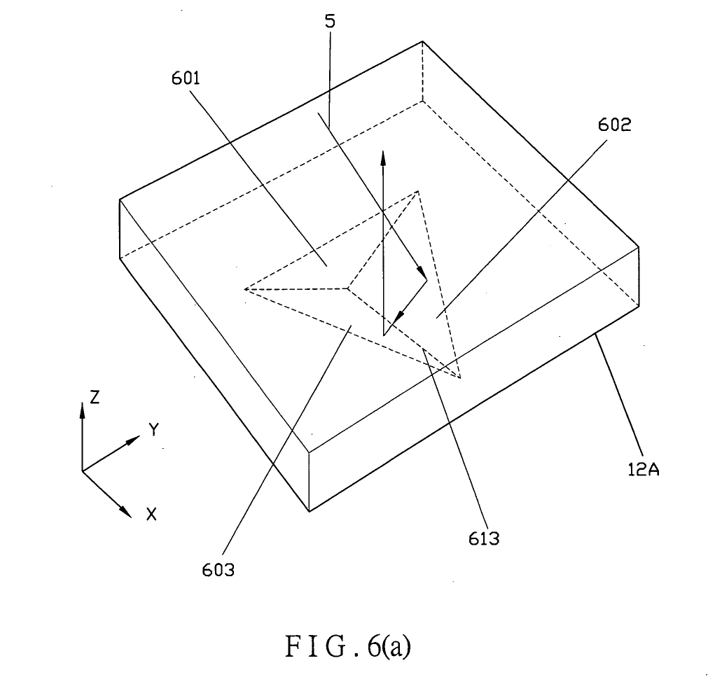

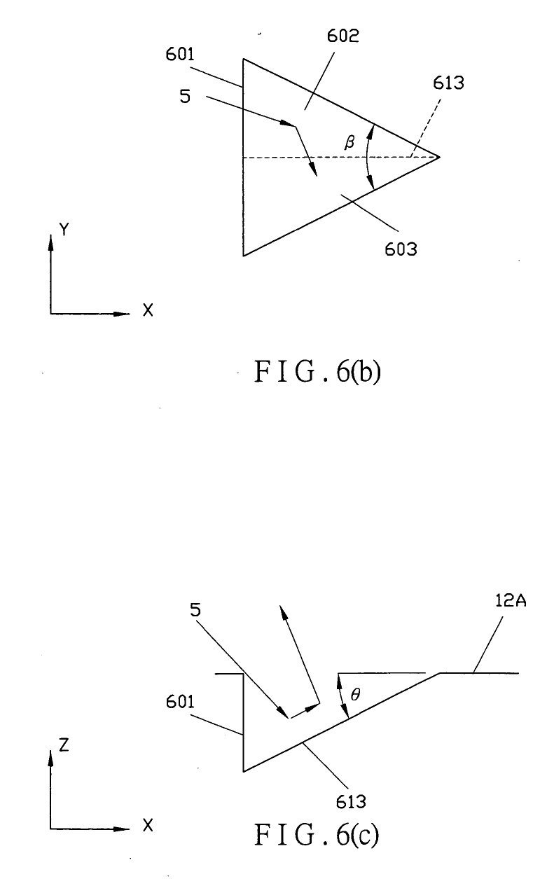

As illustrated in FIGS. 6(a) through 6(c) for a schematic view of the conveyance of rays of light 5 through the micro-reflectors 6, rays of light 5 upon entering into the reflection plane 602 are reflected to another reflection plane 603, where rays of light 5 emit upward. Similarly, rays of light 5 upon entering into the reflection plane 603 emit upward through the reflection plane 602. Angle θ affects the longitudinal inclination (in the direction of Z-axis) of each of the reflection planes 602, 603 to affect the variation of the light intensity on the HA while angle β affects the inclination in lateral direction of the reflection planes 602, 603 (in the direction of Y-axis) to affect the variation of the light intensity on the VA.

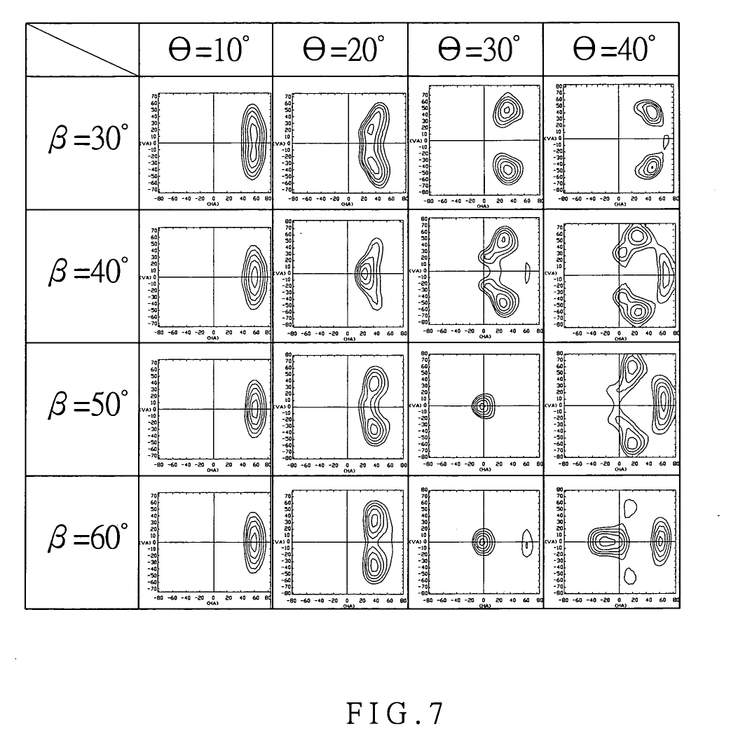

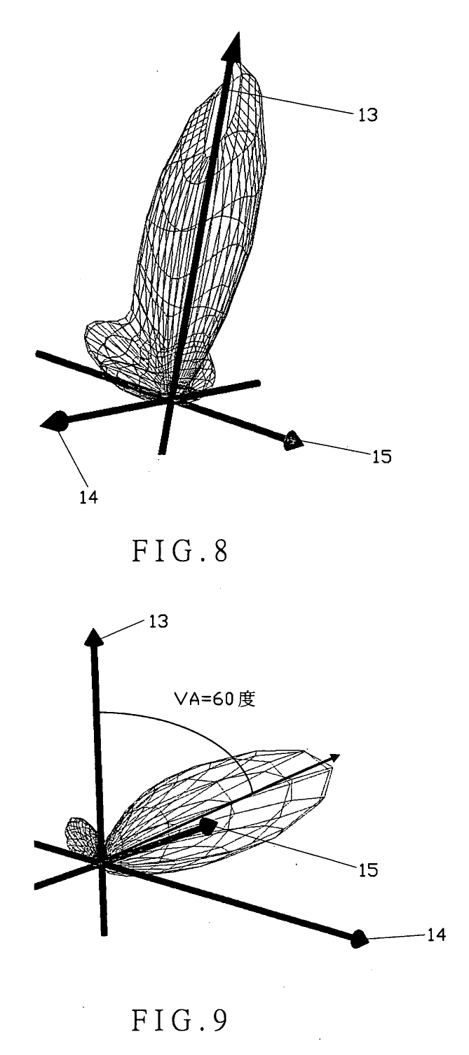

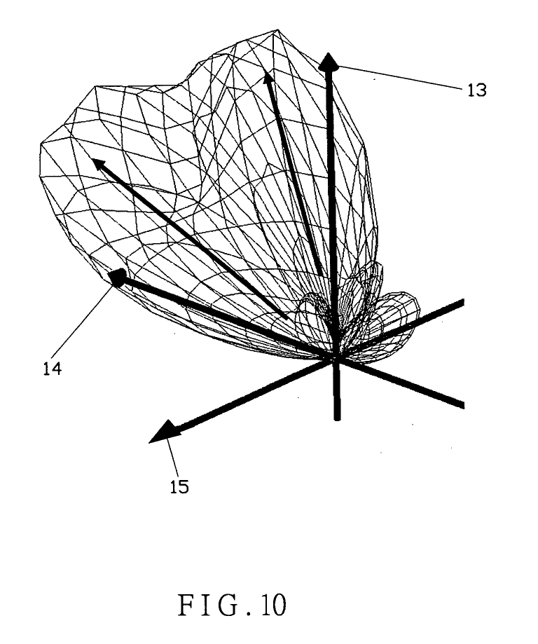

FIG. 7 shows a radar view of the distribution of the illuminating intensity after rays of light having entered into the micro-reflectors 6 with angles β and θ as the parameters. The inventor of the present invention has located on a model designed with the preferred embodiment of the present invention the optimal combinations of angles β and θ that yield the distribution of high illuminating intensity. In the group of design parameters, angle β respectively relates to 30°, 40°, 50°, and 60° while that of angle θ, 10°, 20°, 30°, and 40°. This inventor using ASAP optical software to simulate those parameters has solved that the distribution of high illuminating intensity takes place when angle β is of 50° or 60° and angle θ is of 30°. As illustrated in Fig. 8, rays of light collectively emit in the direction 13, meaning the maximal illuminating intensity is measured in the direction 13 of the normal (VA=0° and HA=0°). When angle θ=10°, rays of light collect at where VA=60° as illustrated in FIG. 9. When angle θ=20°, rays of light collect at where VA=60°, and fork distribution of the illuminating intensity is observed in the vicinity of HA=±30˜40° as illustrated in FIG. 10. Accordingly, variations in angles β and θ affect the illuminating intensity distribution on the illuminating surface 11A of the light guide plate 1A.

Now referring to FIG. 4(b) for the array of the micro-reflectors 6 of the present invention on the light guide plate 1A, in the first preferred embodiment of the distribution, the micro-reflectors 6 distributed on the light guide plate 1A are arranged regularly with the direction 7 of the micro-reflectors 6 is in parallel with that of rays of light emitted from the linear light source 4. Rays of light when emitted by the linear light source 4 enter into the light guide plate 1A and produce a plane light source with highly consistent luminance.

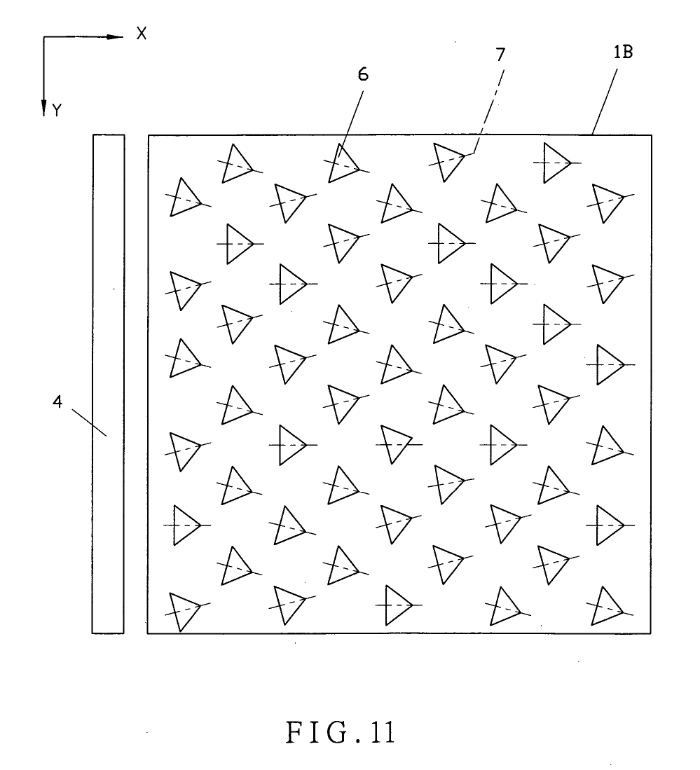

As illustrated in FIG. 11 for a second preferred embodiment of the micro-reflectors 6 of the present invention distributed on a light guide plate 1B, the micro-reflectors 6 are also regularly arranged but the direction 7 is not exactly in parallel with that of rays of light emitted from the linear light source 4; however, in generally, the direction 7 of the micro-reflectors 6 tends to be in parallel with that of rays of light emitted from the linear light source 4. Rays of light emitted from the linear light source 4 enter into the light guide plate 1B and produce a plane light source with highly consistent luminance.

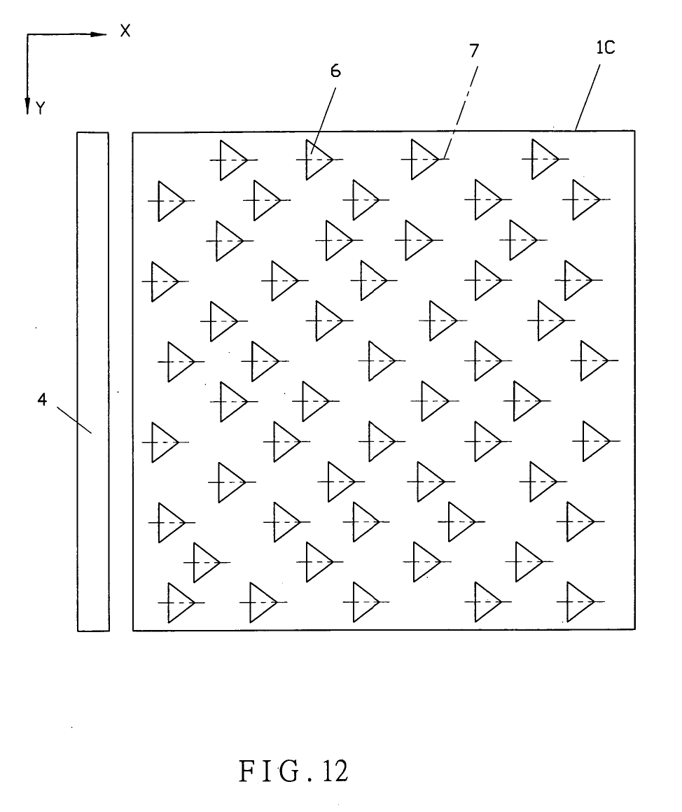

In a third preferred embodiment of the present invention as illustrated in FIG. 12, the micro-reflectors 6 are distributed at random on a light guide plate 1C to indicate the direction 7 in parallel with that of rays of light emitted from the linear light source 4. Rays of light emitted from the linear light source 4 enter into the light guide plate 1C and produce a plane light source with highly consistent luminance.

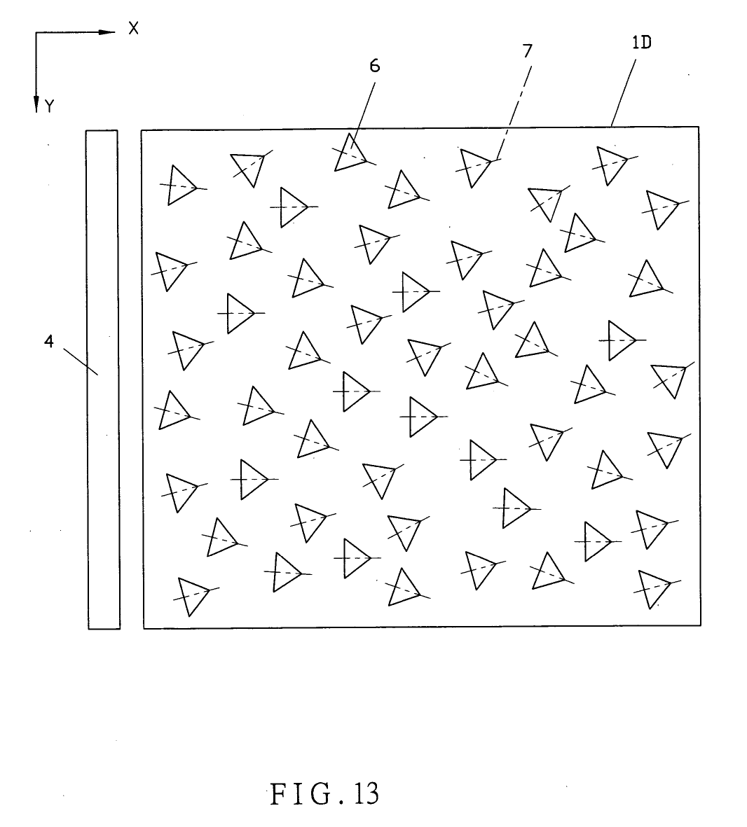

In a fourth preferred embodiment of the present invention as illustrated in FIG. 13, the micro-reflectors 6 are also distributed at random on a light guide plate 1D to indicate the direction 7 not exactly in parallel with that of rays of light emitted from the linear light source 4. However, in generally, the direction 7 of the micro-reflectors 6 tends to be in parallel with that of rays of light emitted from the linear light source 4. Rays of light emitted from the linear light source 4 enter into the light guide plate 1D and produce a plane light source with highly consistent luminance.

Other than the linear light source, e.g., cold cathode tube, applied for those four preferred embodiments described above, multiple point-like light sources, e.g., light emitting diodes may be used as the light source for the arrangement and direction similar to any of those preferred embodiments.

What is claimed is:

1. A light guide plate having micro-reflectors, wherein the light guide plate includes an upper surface and a side; a light source being disposed on the side of the light guide plate; the upper surface of the light guide plate being an illuminating surface; the illuminating surface being on the opposite side to a bottom of the light guide plate; each of the micro-reflectors being shaped like a pyramid disposed on and externally protruding from the bottom of the light guide plate; each pyramid comprising a transparent plane and two reflection planes; the transparent plane being disposed at right angle to the bottom of the light guide plate, facing and comparatively nearer to the light source; the reflection planes being inclined to the bottom of the light guide plate, facing the illuminating surface of the light guide plate and comparatively farther from the light source.

2. The light guide plate having micro-reflectors of claim 1, wherein a sharp edge where both reflection planes meet indicates a direction on the light guide plate; and the direction is exactly in parallel with that of rays of light emitted from the light source.

3. The light guide plate having micro-reflectors of claim 1, wherein a sharp edge where both reflection planes meet indicates a direction on the light guide plate; and the direction is not exactly but tends to be in parallel with that of rays of light emitted from the light source.

4. The light guide plate having micro-reflectors of claim 1, wherein the micro-reflectors are regularly arranged on the light guide plate.

5. The light guide plate having micro-reflectors of claim 1, wherein the micro-reflectors are arranged at random on the light guide plate.
